(19) United States
(12) Patent Application Publication
(10) Pub. No.: US 2025/0356865 A1
(43) Pub. Date: Nov. 20, 2025

(54) Audio Processing Systems and Methods Incorporating Adaptive Extended Time Domain Aliasing Cancellation

(71) Applicant: The Board of Trustees of the Leland Stanford Junior University, Stanford, CA (US)

(72) Inventors: Ryan Wixen, Stanford, CA (US); Marina Bosi, Stanford, CA (US)

(73) Assignee: The Board of Trustees of the Leland Stanford Junior University, Stanford, CA (US)

(21) Appl. No.: 19/209,644

(22) Filed: May 15, 2025

Related U.S. Application Data
(60) Provisional application No. 63/648,499, filed on May 16, 2024.

(51) Int. Cl. G10L 19/02

(52) U.S. Cl. CPC G10L 19/0212

(57) ABSTRACT

Audio processing systems are described that include filter banks capable of performing adaptive extended time-domain aliasing cancellation (TDAC) transforms for efficient audio encoding and decoding. In many instances, the system includes an audio encoder with a time domain to frequency domain mapping filter bank that performs an adaptive extended TDAC transform, which is implemented as a discrete trigonometric transform (DTT) preceded by a folding matrix. A corresponding audio decoder inverts this transform using the transpose of the DTT and folding matrix. This approach enables improved frequency responses with dynamic adjustment of time-frequency resolution based on input signal characteristics, improving coding efficiency.

### CROSS-REFERENCE TO RELATED APPLICATIONS

This application claims priority to U.S. Application No. 63/648,499, titled “Time Varying Extended Evenly and Oddly Stacked Time Domain Aliasing Cancellation (TDAC) Transform”, filed May 16, 2024, which is hereby incorporated by reference in its entirety.

### FIELD OF INVENTION

The present disclosure relates to audio signal processing, and more particularly to adaptive time-frequency transforms for audio coding.

### BACKGROUND

Perceptual audio coding has become a cornerstone of modern digital audio systems, enabling efficient storage and transmission of high-quality audio content. A widely used approach to audio encoding involves filtering the input audio signal into components in various frequency bands. The signal can then be quantized in the frequency domain and a bit pool allocated dynamically depending on the energy of each spectrum component and its relevancy. At the heart of these coding techniques lies the process of time to frequency mapping, which allows for the representation of audio signals in a domain more amenable to compression.

Filter banks can play a crucial role in this time to frequency mapping, providing a framework for decomposing audio signals into their constituent frequency components. These filter banks serve as the foundation for many perceptual audio coding schemes, offering a means to analyze and process audio signals in a manner that aligns with human auditory perception.

One of the primary objectives in perceptual audio coding is the extraction of redundancy from the audio signal. This process involves identifying and eliminating information that is not necessary to uniquely represent the signal. By removing redundant components, audio coders can achieve data rate reduction without significantly impacting the audio quality. The efficiency with which redundant information can be removed typically depends upon the characteristics of the filter bank utilized by the audio encoder.

Complementing redundancy extraction, irrelevancy extraction focuses on removing information that is perceptually insignificant. During audio encoding, irrelevancy extraction processes typically leverage psychoacoustic models to identify components of the audio signal that are unlikely to be perceived by the human ear, allowing for their removal or coarse quantization without noticeable loss in audio quality.

Time-domain aliasing cancellation (TDAC) transforms have emerged as a popular class of filter bank in perceptual audio coding. Audio coders commonly use TDAC transforms, which are critically sampled, perfect reconstruction filter banks or lapped transforms. There are two varieties of TDAC transforms with similar properties, evenly stacked TDAC (ETDAC) transforms and oddly stacked (OTDAC) transforms. As first presented, the TDAC transforms used filters with lengths L=2 M, where M is the transform's hop size. However, both ETDAC and OTDAC transforms can be extended arbitrarily to lengths 2 mM for m ∈ [symbol] . Extended time-domain aliasing cancellation transforms represent an evolution of the basic TDAC concept. These extended transforms allow for longer analysis windows, potentially improving frequency resolution and coding efficiency for certain audio signals. However, they also introduce additional complexity in terms of implementation and adaptation to different signal characteristics. Typically, under steady-state conditions, high-frequency resolution filter banks are ideal not only for redundancy removal but also for effectively exploiting perceptual irrelevancies. However, when the audio signal exhibits a transient-like nature, a filter bank with high time resolution becomes more desirable.

### SUMMARY

Audio coding systems and methods in accordance with various embodiments of the invention involve the use of a filter bank capable of adaptively utilizing an extended time-domain aliasing cancellation filter bank based upon a discrete trigonometric transform (DTT) preceded by a folding matrix.

In one embodiment, the invention includes an audio processing system. The system includes an audio encoder including a time domain to frequency domain mapping filter bank capable of performing an adaptive extended time-domain aliasing cancellation (TDAC) transform, where the adaptive extended TDAC transform includes a discrete trigonometric transform preceded by a folding matrix. The system also includes an audio decoder configured to decode audio signals encoded by the audio encoder using a frequency domain to time domain to mapping filter bank capable of inverting the adaptive extended TDAC transform using a transpose of the DTT and folding matrix.

In another embodiment, the invention includes the audio processing system as described above, where the audio encoder is capable of switching between different extended TDAC transforms using a specific process. This process includes applying an initial extended TDAC transform with a first hop size and a first extension factor using a first steady-state window, applying a cooldown window to the initial transform to gradually reduce the window length of the initial extended TDAC transform, applying a block switch window to bridge between the initial extended TDAC transform and a second extended TDAC transform, applying a warmup window to introduce the second extended TDAC transform, and applying the second extended TDAC transform with a second hop size and a second extension factor using a second steady-state window.

In a further embodiment, the invention includes the audio processing system as described above, where the block switch window has a total length equal to a sum of the first hop size and the second hop size.

In yet another embodiment, the invention includes the audio processing system as described above, where the block switch window is a Bosi-Davidson non-extended block switching window.

In an additional embodiment, the invention includes the audio processing system as described above, where the audio encoder is capable of switching between an extended TDAC transform and a non-extended TDAC transform using a specific process. This process includes applying an initial extended TDAC transform with a first hop size and a first extension factor, applying a cooldown window to the initial transform to gradually reduce the window length of the initial extended TDAC transform, applying a block switch window to bridge between the extended TDAC transform and the non-extended TDAC transform, and applying the non-extended TDAC transform with a second hop size and an extension factor of 1.

In an additional embodiment, the invention includes the audio processing system as described above, where the audio encoder is capable of switching between a non-extended TDAC transform and an extended TDAC transform using a specific process. This process includes applying an initial non-extended TDAC transform with a first hop size and an extension factor of 1, applying a block switch window to bridge between the non-extended TDAC transform and the extended TDAC transform, applying a warmup window to gradually increase the window length of the extended TDAC transform, and applying the extended TDAC transform with a second hop size and a second extension factor.

In a further embodiment, the invention includes the audio processing system as described above, where the block switch window has a total length equal to a sum of the first hop size and the second hop size.

In another embodiment, the invention includes the audio processing system as described above, where the block switch window is a Bosi-Davidson non-extended block switching window.

In yet another embodiment, the invention includes the audio processing system as described above, where the extended TDAC transform is implemented using a fast discrete trigonometric transform of size L/(2 m), where L is a window length and m is an extension factor.

In an additional embodiment, the invention includes the audio processing system as described above, where the fast discrete trigonometric transform emulates or employs a fast Fourier transform.

In a further embodiment, the invention includes the audio processing system as described above, where the extended TDAC transform block switch is implemented using a fast discrete trigonometric transform of size L/2, where L is a Bosi-Davidson non-extended block switch window length.

In another embodiment, the invention includes the audio processing system as described above, where the fast discrete trigonometric transform emulates or employs a fast Fourier transform.

In yet another embodiment, the invention includes the audio processing system as described above, where the adaptive extended TDAC transform includes an extended evenly stacked TDAC (ETDAC) transform.

In an additional embodiment, the invention includes the audio processing system as described above, where the adaptive extended TDAC transform includes an extended oddly stacked TDAC (OTDAC) transform.

In a further embodiment, the invention includes the audio processing system as described above, where the audio encoder is configured to adapt a hop size of the adaptive extended TDAC transform based on characteristics of an input audio signal.

In yet another embodiment, the adaptive extended TDAC transform further utilizes a steady state window characterized by paraunitary lattice coefficients optimized for minimum stopband energies beyond cutoff frequencies ωₛ greater than π/M.

In another embodiment, the invention includes an audio encoder. The audio encoder includes a time domain to frequency domain mapping filter bank that is capable of receiving an input audio signal and perform an adaptive extended time-domain aliasing cancellation (TDAC) transform, where the adaptive extended TDAC transform includes a discrete trigonometric transform preceded by a folding matrix. The audio encoder also includes a psychoacoustic processor operatively connected to the time domain to frequency domain mapping filter bank that is capable of analyzing the input audio signal to determine masking thresholds, a quantizer and encoder operatively connected to the time domain to frequency domain mapping filter bank and the psychoacoustic processor, where the quantizer and encoder is capable of quantizing the frequency domain outputs from the time domain to frequency domain mapping filter bank based on the masking thresholds, and a bit stream formatter operatively connected to the quantizer and encoder and capable of packaging the encoded data into a formatted compressed bitstream.

In yet another embodiment, the invention includes the audio encoder as described above, where the time domain to frequency domain mapping filter bank is capable of switching between different extended TDAC transforms using a specific process. This process includes applying an initial extended TDAC transform with a first hop size and a first extension factor using a first steady-state window, applying a cooldown window to the initial transform to gradually reduce the window length of the initial extended TDAC transform, applying a block switch window to bridge between the initial extended TDAC transform and a second extended TDAC transform, applying a warmup window to introduce the second extended TDAC transform, and applying the second extended TDAC transform with a second hop size and a second extension factor using a second steady-state window.

In an additional embodiment, the invention includes the audio encoder as described above, where the extended TDAC transform is implemented using a fast discrete trigonometric transform of size L/2 m, where L is a window length.

In a further embodiment, the invention includes the audio encoder as described above, where the adaptive extended TDAC transform includes an extended evenly stacked TDAC (ETDAC) transform.

In another embodiment, the invention includes an audio decoder capable of decoding a formatted encoded bitstream created using an adaptive extended time-domain aliasing cancellation (TDAC) transform, where the adaptive extended TDAC includes a discrete trigonometric transform preceded by a folding matrix. The audio decoder includes a bit stream demultiplexer capable of receiving and demultiplexing the formatted encoded bitstream, a decoder and dequantizer operatively connected to the bit stream demultiplexer and capable of processing the demultiplexed bitstream to output a frequency domain representation of a received audio signal, and a frequency domain to time domain mapping filter bank operatively connected to the decoder and dequantizer and capable of converting the frequency domain representation of the received audio signal to a time domain representation of the received audio signal, where the frequency domain to time domain mapping filter bank is capable of inverting the adaptive extended TDAC transform using the transpose of the DTT and folding matrix.

In a further embodiment, the invention includes the audio decoder as described above, where the adaptive extended TDAC transform includes an extended evenly stacked TDAC (ETDAC) transform.

The foregoing general description of the illustrative embodiments and the following detailed description thereof are merely exemplary aspects of the teachings of this disclosure and are not restrictive.

### BRIEF DESCRIPTION OF FIGURES

FIG. 1 illustrates an audio processing system including an audio encoder and an audio decoder implemented in accordance with an embodiment of the invention.

FIGS. 2A and 2B depict a comparison of steady-state extended windows and their corresponding magnitude responses, respectively.

FIG. 3 illustrates an example sequence of extended block switch windows for transitioning between two extended TDAC transforms having different hop sizes in accordance with an embodiment of the invention.

FIG. 4 conceptually illustrates a sequence of modulation matrices utilized by an encoder during the block switch between two extended TDAC transforms in accordance with an embodiment of the invention.

FIG. 5 illustrates an example sequence of extended block switch windows for transitioning between an extended TDAC transform and a non-extended TDAC transform in accordance with an embodiment of the invention.

FIG. 6 illustrates a sequence of modulation matrices for performing the transition between an extended TDAC transform and a non-extended TDAC transform in accordance with an embodiment of the invention.

FIG. 7 illustrates an example sequence of extended block switch windows for transitioning between a non-extended TDAC transform and an extended TDAC transform in accordance with an embodiment of the invention.

FIG. 8 illustrates a sequence of modulation matrices for performing the transition between a non-extended TDAC transform and an extended TDAC transform in accordance with an embodiment of the invention.

FIGS. 9A and 9B present a comparison of a Cooldown A window and windows for two different block switch types, and their scaled magnitude responses, respectively.

### DETAILED DESCRIPTION

Turning now to the drawings, audio processing systems and methods that utilize adaptive extended time-domain aliasing cancellation (TDAC) transforms in accordance with various embodiments of the invention are illustrated. In many embodiments, the audio processing system utilizes a time domain to frequency domain mapping filter bank and a frequency domain to time domain mapping filter bank that are based upon an efficient implementation of an extended TDAC transform. In a number of embodiments, the extended TDAC transform is an evenly stacked TDAC (ETDAC) transform that is adaptive.

The design of filter banks for perceptual audio coding can involve careful consideration of various factors including (but not limited to) frequency selectivity, time resolution, computational complexity, and the ability to adapt to different types of audio content. Balancing these often-competing requirements can be a central challenge in filter bank design.

Window shape and size can be a particularly important parameter in filter bank design, as it directly impacts the trade-off between frequency resolution and time resolution. Larger window sizes generally provide better frequency resolution but poorer time resolution, while smaller window sizes offer the opposite. The optimal window size often depends on the characteristics of the audio signal being processed. In addition, time-domain spreading of quantization noise known as pre-echo may become unmasked for long windows.

In a number of embodiments, an adaptive extended TDAC transform filter bank is utilized that can dynamically adjust its time-frequency resolution based on input signal characteristics. In some implementations, a block switching method may be employed to transition between different transform configurations while on average maintaining critical sampling. For example, audio codecs in accordance with many embodiments of the invention can change between an extended TDAC with a larger hop size with fine frequency resolution during steady-state conditions and an extended or non-extended TDAC transform with a smaller hop size and coarser frequency resolution during transient conditions.

The decision to switch between different extended and/or non-extended TDAC transform configurations may be based on various factors. In some cases, the system may analyze the input signal's temporal and spectral characteristics to determine the optimal transform parameters. This analysis may consider factors such as (but not limited to) transient detection, tonality, spectral-domain flatness measures, time-domain flatness measures, or perceptual criteria derived from psychoacoustic models.

In several embodiments, the extended TDAC transform is implemented using an instantaneously paraunitary lattice followed by a discrete trigonometric transform (DTT). In many embodiments, the extended TDAC transform is computed using a DTT preceded by a sparse folding matrix, where the DTT is of size L/(2 m) preceded by a sparse folding matrix, where L is the window length and m is the extension factor. In many embodiments, the Bosi-Davidson block switch is computed using a DTT preceded by a folding matrix, and the DTT is of size L/2, where L=Mₐ+M_{b} is the length of the Bosi-Davidson non-extended block switch window. These formulations enable the use of existing fast DTT algorithms, reducing computational complexity.

Audio processing systems and methods that utilize filter banks based upon adaptive extended TDAC transformations in accordance with various embodiments of the invention are discussed further below.

### Audio Processing Systems

Audio processing systems in accordance with many embodiments of the invention perform perceptual audio encoding and decoding using filter banks that are based upon an adaptive extended TDAC transform. Use of an adaptive extended TDAC transform can allow for dynamic adjustment of window lengths and hop sizes to better accommodate varying audio signal characteristics. This approach can enhance the efficiency and quality of audio compression.

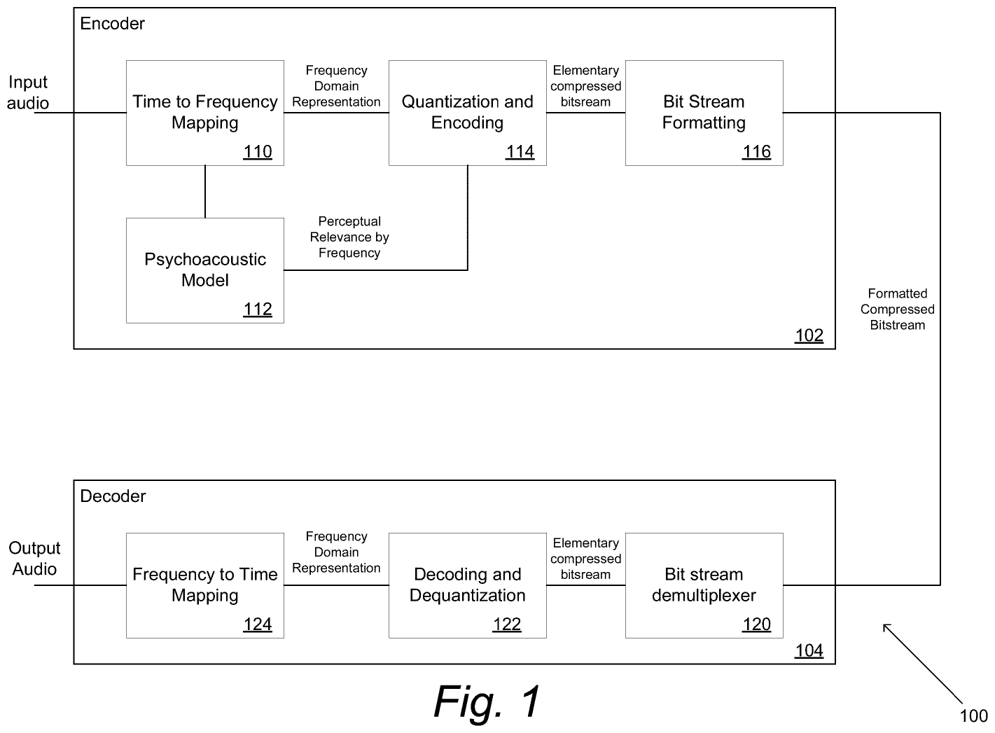

An audio processing system including an audio encoder and an audio decoder in accordance with an embodiment of the invention is illustrated in FIG. 1. The audio processing system 100 includes an audio encoder that receives an input audio signal. In a number of embodiments, the input audio signal is a Pulse-Code Modulation (PCM) signal. As can readily be appreciated, any of a variety of different audio signal formats can be utilized as appropriate to the requirements of specific applications.

The audio encoder 102 processes the input audio signal using a time domain to frequency domain mapping filter bank 110. In the illustrated embodiment, the time domain to frequency domain mapping filter bank 110 employs an adaptive extended TDAC transform capable of switching between different window lengths, window types, and/or hop sizes. Various extended and non-extended TDAC transforms and block switching processes that can be utilized within audio processing systems in accordance with a variety of different embodiments of the invention are discussed further below.

A psychoacoustic processor 112 can analyze the audio to determine masking thresholds based on human auditory perception. A quantizer and encoder 114 is capable of quantizing the frequency domain outputs from the time domain to frequency domain mapping filter bank 110 based on these masking thresholds. A bit stream formatter 116 can then package the encoded data into a formatted compressed bitstream for transmission or storage. The specific implementations of the psychoacoustic processor 112, quantizer and encoder 114, and bit stream formatter 116 are largely dependent upon the requirements of specific applications and can be based upon any of the implementations that are widely utilized within various video codecs. Indeed filter banks implemented in accordance with many embodiments of the invention can be direct replacements for filter banks in existing audio encoders and/or decoders.

Referring again to FIG. 1, the audio decoder 104 may include a bit stream demultiplexer 120 that receives and demultiplexes the formatted compressed bitstream. A decoder and dequantizer 122 and a frequency domain to time domain mapping filter bank 124 are capable of processing the demultiplexed bitstream to reconstruct output audio. The frequency domain to time domain mapping filter bank 124 is capable of converting the frequency domain representation back to the time domain with the transpose, or paraconjugate, of the adaptive extended TDAC transform utilized within the audio encoder 102.

In many embodiments, the audio encoder applies TDAC modulation matrices to windowed blocks of length L of time domain audio samples to obtain blocks of length L/(2 m) of frequency domain samples, where m is the extension factor. Then, in the decoder, to reconstruct the time domain samples from the frequency domain dequantized samples, the transpose of the TDAC modulation matrices is applied and then the audio decoder can window, overlap, and add the results.

While much of the discussion that follows focuses on the implementation of filter banks within audio encoders and processes for performing block switching within audio coders, it should be readily appreciated that audio decoders are commonly specified based upon the manner in which audio is encoded and can be readily implemented based upon the specification of the manner in which an audio encoder encodes audio. Accordingly, the description of the filter banks and/or block switching processes implemented in audio encoders serves as an explanation for the manner in which filter banks and/or block switching processes can be implemented within an audio decoder in order to reverse the audio encoding process to obtain an output audio signal capable of being played back via an appropriate audio renderer.

While specific audio processing systems, audio encoders, and audio decoders are described above with reference to FIG. 1, alternative implementations are possible. The specific configuration and arrangement of components within the audio encoder and/or audio decoder may vary depending on particular application requirements or design preferences as appropriate to the requirements of specific applications. Adaptive extended TDAC transforms and filter banks implemented in accordance with various embodiments of the invention are discussed further below.

### Adaptive Extended TDAC Transforms

Audio processing systems, audio encoders, and audio decoders can be implemented in accordance with various embodiments of the invention based upon a framework for describing adaptive TDAC transforms utilizing DTTs and sparse folding matrices. Specifically, implementations can be based upon a generalized formulation of adaptive extended TDAC transforms as DTTs preceded by sparse folding matrices, or instantaneous paraunitary lattices. In this framework, each adaptive TDAC modulation matrix can be written as an orthonormal DTT preceded by a sparse folding matrix. To transition from a hop size of Mₐ to hop size of M_{b} using a Bosi-Davidson non-extended block switch window of length L=Mₐ+M_{b}, for an adaptive ETDAC cosine block, the relevant orthonormal discrete cosine transform (DCT) Cₑ of order L/2 has elements

$${[ {C}_{e} ]}_{kn} = ψ ( k ) \sqrt{\frac{2}{L / 2}} cos ( \frac{π}{L / 2} k ( n + \frac{1}{2} ) )$$

$$k = 0 , … , L / 2 - 1$$

$$n = 0 , … , L / 2 - 1$$

For an adaptive ETDAC sine block, the relevant orthonormal discrete sine transform (DST) Sₑ of order L/2 has elements

$${[ {S}_{e} ]}_{kn} = ψ ( k + 1 ) \sqrt{\frac{2}{L / 2}} sin ( \frac{π}{L / 2} ( k + 1 ) ( n + \frac{1}{2} ) )$$

$$k = 0 , … , L / 2 - 1$$

$$n = 0 , … , L / 2 - 1$$

To normalize their energy, the rows and columns of the orthonormal DTTs are weighted with ψ: [symbol] → [symbol] , defined

$$ψ ( x ) \{ \begin{matrix}\frac{1}{\sqrt{2}} & x ∈ \{ 0 , L / 2 \} \\ 1 & else\end{matrix} ,$$

which reduces the gain of any rows or columns at zero frequency or Nyquist frequency. As defined above, Cₑ and Sₑ are the orthonormal DCT and DST of type II. Using the orthonormal DTTs Cₑ and Sₑ as defined above, the adaptive ETDAC cosine and sine modulation matrices can be expressed as

$${T}_{e , c}^{( 1 )} = {C}_{e} {F}_{e , c}$$

$${T}_{e , s}^{( 1 )} = {S}_{e} {F}_{e , s}$$

where F_{e,c} ∈ [symbol] ^{L/2×L} and F_{e,s} ∈ [symbol] ^{L/2×L} are

$${F}_{e , c} = [ [ \begin{matrix}0 \\ {I}_{\frac{{M}_{a}}{2}}\end{matrix} ] {J}_{L / 2} [ \begin{matrix}{I}_{\frac{{M}_{b}}{2}} \\ 0\end{matrix} ] ] ,$$

$${F}_{e , s} = [ [ \begin{matrix}0 \\ {I}_{\frac{{M}_{a}}{2}}\end{matrix} ] - {J}_{L / 2} [ \begin{matrix}{I}_{\frac{{M}_{b}}{2}} \\ 0\end{matrix} ] ] ,$$

with the anti-diagonal unitary matrix J. Honoring the DTTs' symmetries and boundary conditions, the folding matrices F_{e,c} and F_{e,s} lengthen the DTTs' sinusoidal rows. In this way the adaptive ETDAC modulation matrices can be expressed as

$${[ {T}_{e , c}^{( 1 )} ]}_{kn} = ψ ( k ) \sqrt{\frac{2}{L / 2}} cos ( \frac{π}{L / 2} k ( n + {n}_{0} ) )$$

$$k = 0 , … , L / 2 - 1$$

$$n = 0 , … , L - 1$$

$${[ {T}_{e , s}^{( 1 )} ]}_{kn} = ψ ( k + 1 ) \sqrt{\frac{2}{L / 2}} sin ( \frac{π}{L / 2} ( k + 1 ) ( n + {n}_{0} ) )$$

$$k = 0 , … , L / 2 - 1$$

$$n = 0 , … , L - 1$$

Adaptive TDAC transforms use the time offset:

$${n}_{0} = \frac{{M}_{b} + 1}{2}$$

and the rows of both adaptive ETDAC transforms are weighted with just like the rows and columns of the orthonormal DTTs.

The steady-state extended ETDAC transform can be defined using the same building blocks as the adaptive non-extended ETDAC transform. In the steady-state case, Mₐ=M_{b}=M. In this steady-state case, with an extension factor m, we can define the extended ETDAC cosine modulation matrix

$${T}_{e , c}^{( m )}$$

∈ [symbol] ^{M×2mM} and the extended ETDAC sine modulation modulation matrix

$${T}_{e , s}^{( m )}$$

∈ [symbol] ^{M×2mM as}

$${T}_{e , c}^{( m )} = {T}_{e , c}^{( 1 )} [ \begin{matrix}{1}_{2 M} & {I}_{2 M} & {I}_{2 M} & …\end{matrix} ]$$

$${T}_{e , s}^{( m )} = {T}_{e , s}^{( 1 )} [ \begin{matrix}{1}_{2 M} & {I}_{2 M} & {I}_{2 M} & …\end{matrix} ]$$

The above tiling matrices lengthen the sinusoidal rows of the non-extended modulation matrices and thereby the DTTs.

Since the tiling and folding matrices simply lengthen the sinusoidal rows of the DTTs, the extended ETDAC modulation matrices can be expressed explicitly in terms of sinusoids. The extended ETDAC cosine modulation matrix is

$${[ {T}_{e , c}^{( m )} ]}_{kn} = ψ ( k ) \sqrt{\frac{2}{M}} cos ( \frac{π}{M} k ( n + {n}_{0} ) )$$

$$k = 0 , … , M - 1$$

$$n = 0 , … , 2 mM - 1 ,$$

and the extended ETDAC sine modulation matrix is

$${[ {T}_{e , s}^{( m )} ]}_{kn} = ψ ( k + 1 ) \sqrt{\frac{2}{M}} sin ( \frac{π}{M} ( k + 1 ) ( n + {n}_{0} ) )$$

$$k = 0 , … , M - 1$$

$$n = 0 , … , 2 mM - 1 .$$

Steady-state extended TDAC modulation matrices use the time offset n₀ with M_{b}=M, and their rows are weighted with ψ as defined above.

The above formulation of the adaptive extended ETDAC transforms as DTTs preceded by folding matrices enables fast implementation of filter banks in accordance with various embodiments of the invention. The ETDAC transform can be computed using size L/2 DTTs with linear, O(mL), additional computation for the folding and tiling matrices and the window, similar to as observed for the OTDAC transform. Fast O (L log(L)) algorithms for computing the DTTs are known that emulate or employ the fast Fourier transform and be implemented with standard hardware accelerators. In many embodiments, such algorithms are implemented for the DTTs, where L is highly composite, meaning the prime factors of L are small.

In a number of embodiments the ETDAC modulation matrices are applied to windowed blocks of time domain inputs to obtain blocks of frequency domain outputs. To reconstruct the time domain inputs from the frequency domain outputs, the transpose of the ETDAC modulation matrices can be applied to the frequency domain blocks, and then the results windowed, overlapped, and added. Therefore, taking the transpose of a fast implementation for the ETDAC analysis stage can also yield a fast implementation for the ETDAC synthesis stage.

As noted above, the above formulation provides a framework for the implementation of filter banks. Using the extended ETDAC modulation matrices and the window p₀ ∈ R^{2mM}, the steady state extended ETDAC transform can be expressed as an instantaneously paraunitary system. The ETDAC transform's modulation matrix

$${T}_{e}^{( m )} [ n ]$$

∈ [symbol] ^{M×2mM} can be defined as

$${T}_{e}^{( m )} [ n ] = \{ \begin{matrix}{T}_{e , c}^{( m )} & n \%2 = 0 \\ {T}_{e , s}^{( m )} & n \%2 = 1\end{matrix} .$$

The ETDAC transform is a critically sampled periodically time varying system ↓_{M} h[nᵢ](z) ∈ [symbol] ^{M}, where nᵢ is the input time-index and n is the output time index

$${↓}_{M} h [ {n}_{i} ] ( z ) = {T}_{e}^{( m )} [ n ] J diag ( {p}_{0} ) {↓}_{M} {e}^{( m )} ( z ) ,$$

where e^{(m)}(z) ∈ [symbol] ^{M} is the delay line,

$${e}^{( m )} ( z ) = ( {z}^{0} , {z}^{- 1} , … , {z}^{- ( 2 mM - 1 )} ) ,$$

J is the anti-diagonal unitary matrix, and ↓_{M} is the M-downsampling operator. J is applied before the modulation matrix to align the formulation with the convention commonly implemented in code, where the window w=Jp₀ is considered the time reversal of the prototype filter. The expression for the extended ETDAC transform can be further reduced by defining the 2 M-polyphase components of the prototype filter

$${G}_{k} ( z ) = {\sum }_{i = 0}^{m - 1} {p}_{0} [ 2 Mi + k ] {z}^{- i}$$

$$k = 0 , … , 2 M - 1$$

and putting these polyphase components into two diagonal matrices

$${[ {g}_{0} ( z ) ]}_{kk} = {G}_{k} ( z ) \qquad {[ {g}_{1} ( z ) ]}_{kk} = {G}_{k + M} ( z )$$

$$k = 0 , … , M - 1 .$$

As a result, the extended ETDAC transform can be implemented as a filter bank in accordance with following formulation

$${↓}_{M} h [ {n}_{i} ] ( z ) = {T}_{e}^{( 1 )} [ n ] J [ \begin{matrix}{g}_{0} ( {z}^{2} ) \\ {z}^{- 1} {g}_{1} ( {z}^{2} )\end{matrix} ] {↓}_{M} {e}^{( m )} ( z ) ,$$

where e(z) ∈ [symbol] ^{M} is the delay line,

$$e ( z ) = ( {z}^{0} , {z}^{- 1} , … , {z}^{- ( 2 mM - 1 )} ) .$$

While various implementations for extended TDAC transforms are described above based upon formulating the extended TDAC transform as a linear system, any of a variety of approaches for implementing filter banks in audio encoders and audio decoders based upon an extended TDAC transform appropriate to the requirements of specific applications can be utilized in accordance with various embodiments of the invention. Furthermore, many of the formulations that are described herein for performing extended TDAC transforms with even M can also be readily modified to enable performance of extended TDAC transforms with odd M. Processes for windowing extended TDAC transforms and performing block switching between various extended and/or non-extended TDAC transforms in accordance with a number of embodiments of the invention are discussed further below.

### Steady-State Extended Window

In extended TDAC transforms, window size may play a crucial role in balancing time and frequency resolution. Larger window sizes may provide improved frequency selectivity, potentially enhancing the representation of steady-state signals. Conversely, smaller window sizes may can offer better temporal resolution, which may be beneficial for capturing transient events. By switching between different extended and/or non-extended TDAC transforms with varying window sizes, an audio processing system may adapt to diverse signal characteristics, potentially optimizing the time-frequency representation for different audio content.

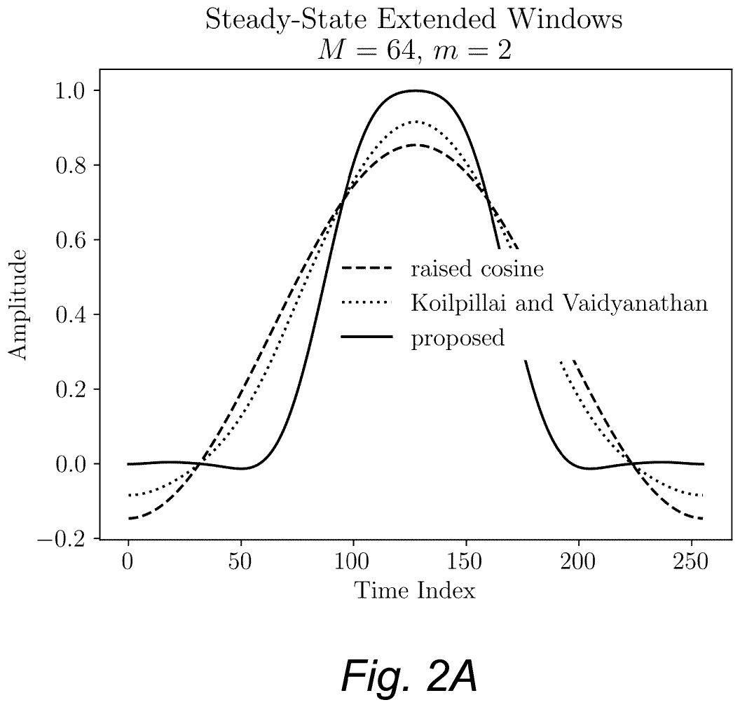

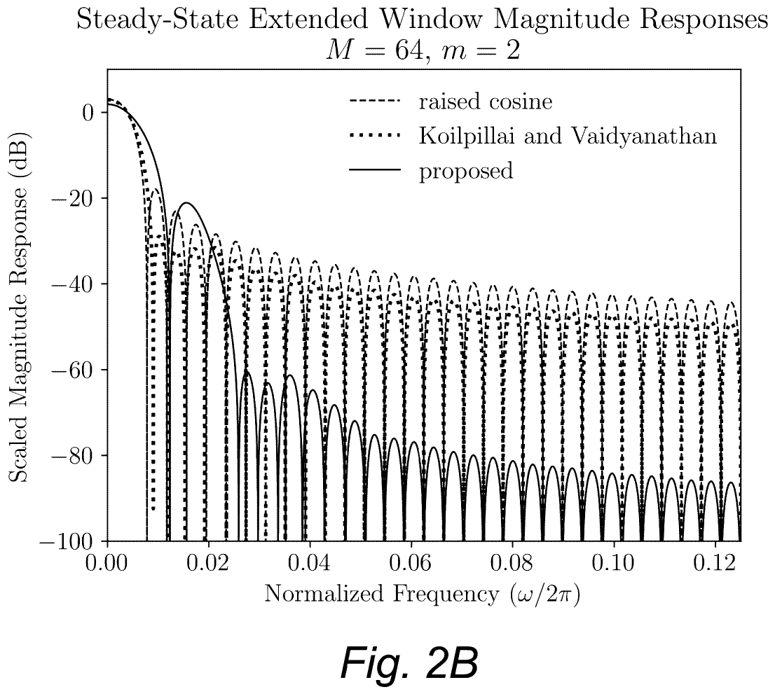

Specific steady-state extended windows may be employed in extended TDAC transforms to achieve desired spectral properties. FIG. 2A illustrates a comparison of steady-state extended windows with M=64 and m=2, where M represents the transform hop size and m is the extension factor. The graph depicts three window functions: a raised cosine window, a minimum stopband energy window with cutoff frequency ωₛ=π/M previously described in the academic literature, and a proposed minimum stopband energy window optimized for ωₛ=3.2 π/M. This window is an example of a proposed class of perfect reconstruction window whose paraunitary lattice coefficients are optimized for minimum stopband energies beyond cutoff frequencies ωₛ greater than π/M. This design enables greater ultimate rejection, which is particularly desirable for audio applications. FIG. 2B presents the corresponding magnitude responses of these windows. As shown in FIG. 2B, the proposed minimum stopband energy window can achieve improved stopband attenuation compared to both the raised cosine and previous minimum stopband energy windows, providing enhanced ultimate rejection when utilized with extended TDAC transforms implemented in accordance with various embodiments of the invention.

While specific steady-state window functions for use in combination with extended TDAC transforms are described above with reference to FIGS. 2A and 2B, the specific choice of window function and parameters may depend on particular application requirements or design preferences, allowing for flexibility in optimizing the extended TDAC transform for various audio processing scenarios. Various windows that allow for perfect (or near-perfect) reconstruction and can be applied when performing block switching between various extended and/or non-extended TDAC transforms in accordance with a number of embodiments of the invention are discuss further below.

Adaptive Extended ETDAC Transforms based upon Paraunitary Lattices

Systems and methods for performing audio processing in accordance with many embodiments of the invention can utilize an instantaneously paraunitary lattice formulation of the ETDAC transform to achieve an adaptive extended ETDAC transform. The extended ETDAC transform can be formulated as an instantaneously paraunitary lattice followed by a DTT.

A sequence of paraunitary rotation matrices, Θᵢ ∈ [symbol] ^{M×M}, can be defined for i=0, . . . , m−1,

$${Θ}_{i} = [ \begin{matrix}{S}_{i} & - {C}_{i} J \\ - {JC}_{i} & - {JS}_{i} J\end{matrix} ] \qquad i = 0 , … , m - 1$$

$$with$$

$${S}_{i} = diag ( sin ( {θ}_{0 , i} ) , sin ( {θ}_{1 , i} ) , … , sin ( {θ}_{\frac{M}{2} - 1 , i} ) )$$

$${C}_{i} = diag ( cos ( {θ}_{0 , i} ) , cos ( {θ}_{1 , i} ) , … , cos ( {θ}_{\frac{M}{2} - 1 , i} ) )$$

$$i = 0 , … , m - 1 ,$$

where θ_{j,i} ∈ [symbol] for i=0, . . . , m−1 and j=0, . . . , M/2−1 are a set of rotation angles that parameterize the set of linear phase perfect reconstruction TDAC prototype filters.

The following paraunitary delay matrix, Λ(z) ∈ [symbol] ^{M×M}, can be defined

$$Λ ( z ) = [ \begin{matrix}{z}^{- 1} {I}_{M / 2} & \\ & {I}_{M / 2}\end{matrix} ] .$$

Instantaneously paraunitary matrices that enable the ETDAC transform's alternation between cosine and sine blocks can defined based upon the above. A instantaneously unitary matrix Z[n] ∈ [symbol] ^{M×M} that alternates between the DCT and DST with Mₐ=M_{b}=M.

$$Z [ n ] = \{ \begin{matrix}{C}_{e} & n \%2 = 0 \\ {S}_{e} & n \%2 = 1\end{matrix}$$

Two instantaneously unitary matrices can also be defined to pre-process and post-process the samples of the paraunitary lattice, A[n], B[n] ∈ [symbol] ^{M×M}.

$$A [ n ] = [ \begin{matrix}{( - 1 )}^{m - 1 + n} {I}_{M / 2} & \\ & {I}_{M / 2}\end{matrix} ]$$

$$B [ n ] = [ \begin{matrix} & {( - 1 )}^{n + 1} {I}_{M / 2} \\ {I}_{M / 2} & \end{matrix} ]$$

The above paraunitary building blocks can be used to define the extended ETDAC transform as an instantaneously paraunitary lattice followed by a DTT. Using nᵢ to reference the input time-index and n to reference the output time index, the ETDAC transform is a critically sampled, periodically time varying system ↓_{M} h[nᵢ](z) ∈ [symbol] ^{M},

$$\begin{matrix}{↓}_{M} h [ {n}_{i} ] ( z ) = {↓}_{M} E [ {n}_{i} ] ( {z}^{M} ) e ( z ) \\ = E [ n ] ( z ) {↓}_{M} e ( z )\end{matrix} ,$$

where E[n](z) ∈ [symbol] ^{M×M} is the instantaneously paraunitary polyphase matrix

$$E [ n ] ( z ) = Z [ n ] B [ n ] Λ ( z ) {Θ}_{m - 1} Λ ( {z}^{2} ) … Λ ( {z}^{2} ) {Θ}_{0} A [ n ] J ,$$

and e(z) is the delay line defined above.

The polyphase matrix defined above is a cascade of instantaneously paraunitary building blocks. Therefore, the extended ETDAC transform's polyphase matrix E[n](z) is instantaneously paraunitary at each time n.

While the polyphase matrix defined above can be utilized to construct an instantaneously paraunitary lattice within a filter bank, audio processing systems implemented in accordance with various embodiments of the invention are not limited to the use of these specific instantaneously paraunitary lattices and/or ETDAC transforms. The manner in which paraunitary lattice implementations of the extended ETDAC transform can be utilized in the implementation of filter banks capable of performing adaptive extended ETDAC transforms in accordance with various embodiments of the invention is discussed further below.

### Block Switching Methods for Adaptive Extended TDAC Transforms

Audio processing systems in accordance with many embodiments of the invention are capable of block switching to transition between different extended and/or non-extended TDAC transforms. This transition process may allow for dynamic adaptation of the time-frequency resolution based on input signal characteristics. A variety of examples are presented below involving the use of extended and/or non-extended TDAC transforms having even hop sizes. It should be readily appreciated that similar approaches can be utilized to perform block switching between non-extended and/or extended TDAC transforms, and/or TDAC transforms having odd hop sizes.

Adaptive extended TDAC transforms can utilize different methods to switch between block sizes. In a number of embodiments, Bosi-Davidson block switching method is utilized. The Bosi-Davidson non-extended block switching method was originally designed for adaptive ETDAC transforms, but has also been applied to adaptive OTDAC transforms. To transition from a hop size of Mₐ to a hop size of M_{b}, the Bosi-Davidson block switching method uses a bridge transform with a window of length L=Mₐ+M_{b} constructed as the first half of the window used for the Mₐ transform followed by the second half of the window used for the M_{b} transform. The adaptive non-extended TDAC transforms reduce to the steady-state transforms when Mₐ=M_{b}=M.

In a number of embodiments, the block switching process involves “warming up” and “cooling down” the extended TDAC transforms, while maintaining in average critical sampling. For example, block switching processes in accordance with certain embodiments of the invention can employ the following distinct phases:

1. Steady-state A: An initial extended TDAC transform is applied with a hop size of Mₐ.
2. Cooldown A: A cooldown window may be applied to the initial extended TDAC transform. This cooldown window may gradually reduce the window length of the initial extended TDAC transform over time.
3. Block switch: A transition window may be employed to bridge between the two different hop sizes. In many embodiments a Bosi-Davidson block switch window is employed that has a total length of Mₐ+M_{b}, where Mₐ is the hop size of the initial extended TDAC transform and M_{b} is the hop size of the second extended TDAC transform.
4. Warmup B: A warmup window may be applied to introduce the second extended TDAC transform. This warmup window gradually increases the window length of the second extended TDAC transform.
5. Steady-state B: The second extended TDAC transform is fully applied with a hop size of M_{b}.

During the transition process, the extended block switch windows may be carefully designed and applied to maintain critical sampling and cancel time-domain aliasing. The Cooldown A window can be implemented as a length 4 Mₐ window that zeros out a portion of the initial TDAC transform's output, while the Warmup B window for the second TDAC transform can be implemented as the time reversal of the length 4 M_{b} cooldown window for the hop size M_{b}. This overlapping and zeroing process can help provide a smooth transition between the two extended TDAC transforms.

When switching between an extended TDAC transform and a non-extended TDAC transform, the shorter window length of the of the non-extended TDAC transform can mean that application of a warmup window is not required. When switching between a non-extended TDAC transform and an extended TDAC transform, the shorter window length of the of the non-extended TDAC transform can mean that application of a cooldown window is not required. Specific examples involving switching between different extended and/or non-extended TDAC transforms in accordance with various embodiments of the invention are discussed further below.

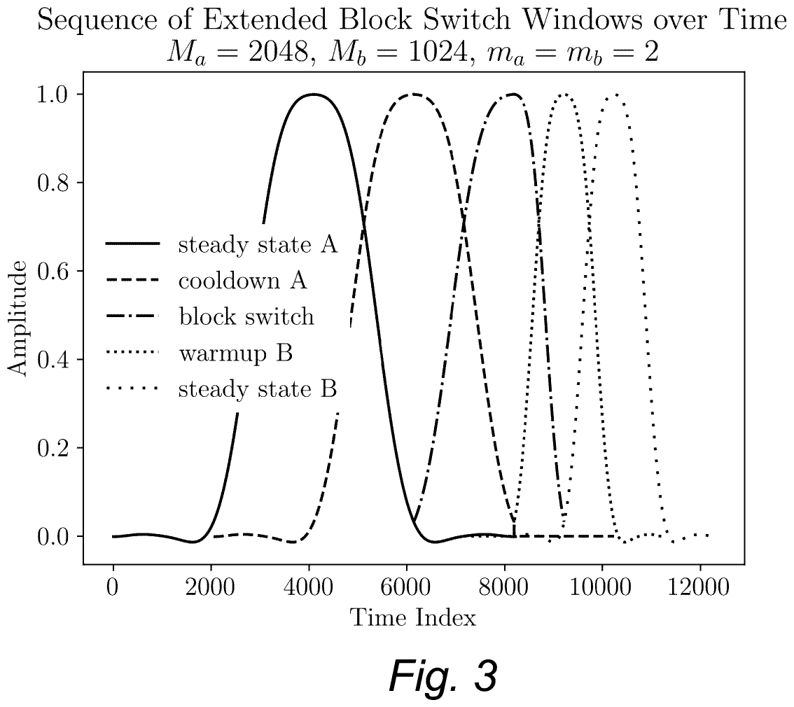

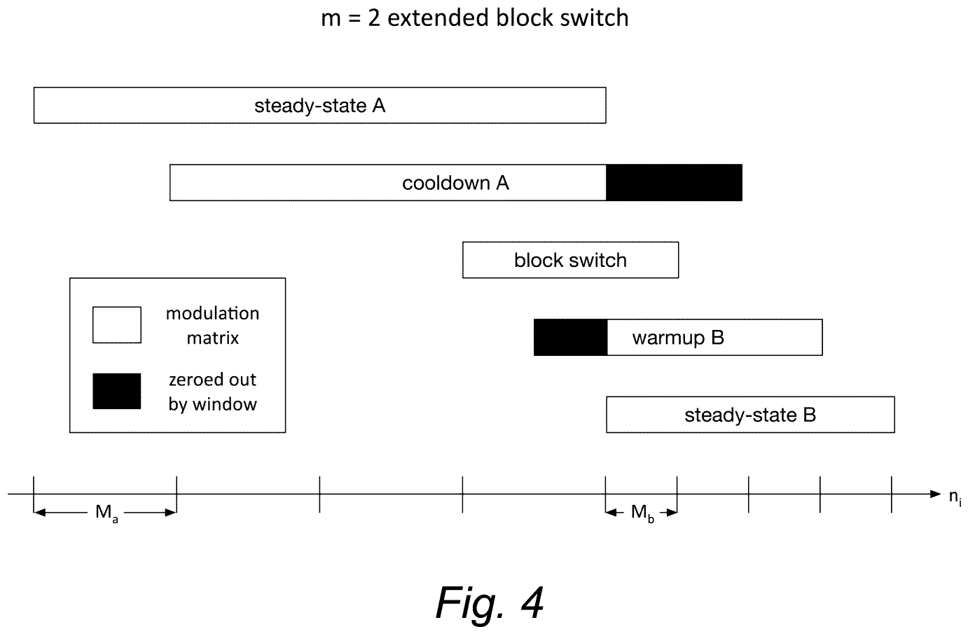

FIG. 3 illustrates an example sequence of extended block switch windows for transitioning between two extended TDAC transforms having hop sizes of Mₐ and M_{b}, both with m=2. The sequence of modulation matrices utilized by an encoder during the block switch between the two extended TDAC transforms is conceptually illustrated in FIG. 4.

During the Steady-state A phase, a Steady-state A window can be applied in combination with the modulation matrix for the initial extended TDAC transform having a hop size of Mₐ. In anticipation of the block switch, the Cooldown A phase commences in which a cooldown modulation matrix is applied. As shown in FIG. 4, the Cooldown A window begins Mₐ samples after the beginning of the previous block's window. The rightmost portion of the cooldown matrix may be zeroed out by the cooldown window function. In a number of embodiments, the cooldown window w_{c} ∈ [symbol] ^{4M}^{ₐ} can be expressed in terms of the steady state window wₐ from which it is derived as follows:

$${w}_{c} [ n ] = \{ \begin{matrix}{w}_{a} [ n ] & 0 \leq n < {M}_{a} \\ \sqrt{{{w}_{a} [ n ]}^{2} + {{w}_{a} [ n - {M}_{a} ]}^{2}} & {M}_{a} \leq n < 2 {M}_{a} \\ {w}_{a} [ n ] & 2 {M}_{a} \leq n < 3 {M}_{a} \\ 0 & 3 {M}_{a} \leq n < 4 {M}_{a}\end{matrix}$$

The above cooldown modulation matrix may gradually reduce the window length of the first TDAC transform over time.

After the cooldown window, there is a non-extended block switch. With the new steady-state window w_{b}, using a non-extended Bosi-Davidson block switch, in order to satisfy the perfect reconstruction condition the non-extended block switch window wₛ ∈ [symbol] ^{M}^{ₐ}^{+M}^{_{b}} can be implemented as follows:

$${w}_{s} = ( \begin{matrix}\sqrt{{{w}_{a} [ 0 ]}^{2} + {{w}_{a} [ {M}_{a} ]}^{2}} \\ ⋮ \\ \sqrt{{{w}_{a} [ {M}_{a} - 1 ]}^{2} + {{w}_{a} [ 2 {M}_{a} - 1 ]}^{2}} \\ \sqrt{{{w}_{b} [ n + 2 {M}_{b} ]}^{2} + {{w}_{b} [ n + 3 {M}_{b} ]}^{2}} \\ ⋮ \\ \sqrt{{{w}_{b} [ n + 3 {M}_{b} - 1 ]}^{2} + {{w}_{b} [ n + 4 {M}_{b} - 1 ]}^{2}}\end{matrix} )$$

The above block switch window achieves the switch from Mₐ to M_{b} with an appropriate adaptive kernel. Finally, as noted above, the warmup window for M_{b} can be the time reversal of the length 4 M_{b} cooldown window for the hop size M_{b}. The warmup matrix will gradually increase the window length of the second extended TDAC transform. As depicted in FIG. 4, the leftmost portion of the warmup matrix is zeroed out by the window function. Following the completion of the Warmup B phase, the transform is in the Steady-state B phase for the second extended TDAC transform having a hop size of M_{b}.

In some cases, an audio coder may switch between extended and non-extended TDAC transforms to adapt to varying signal characteristics in order to minimize pre-echo distortion. This switching capability may allow the system to balance frequency selectivity and temporal resolution based on input audio content. The decision to switch between extended and non-extended TDAC transforms may be based on factors such as signal transients, spectral flatness, or perceptual criteria derived from psychoacoustic models.

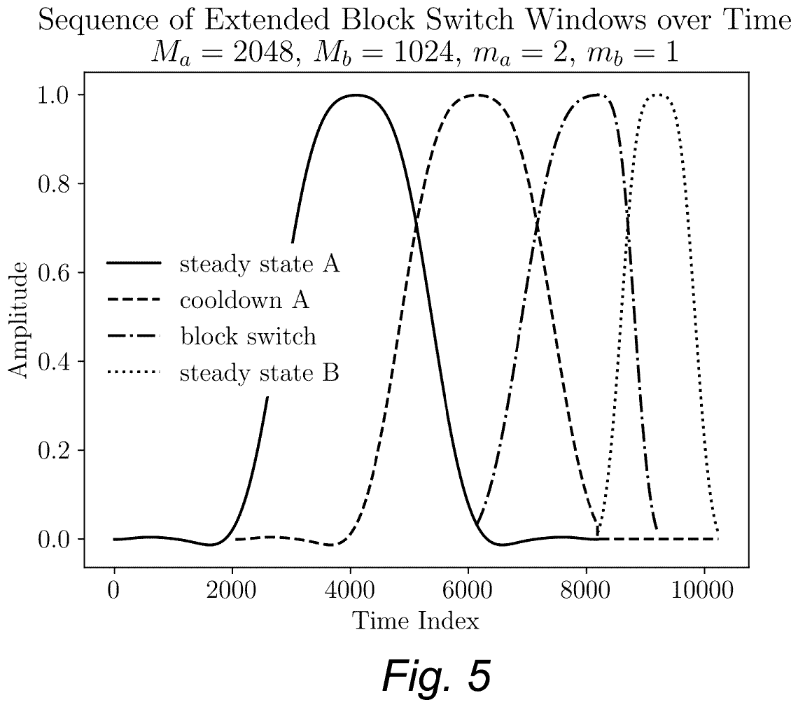

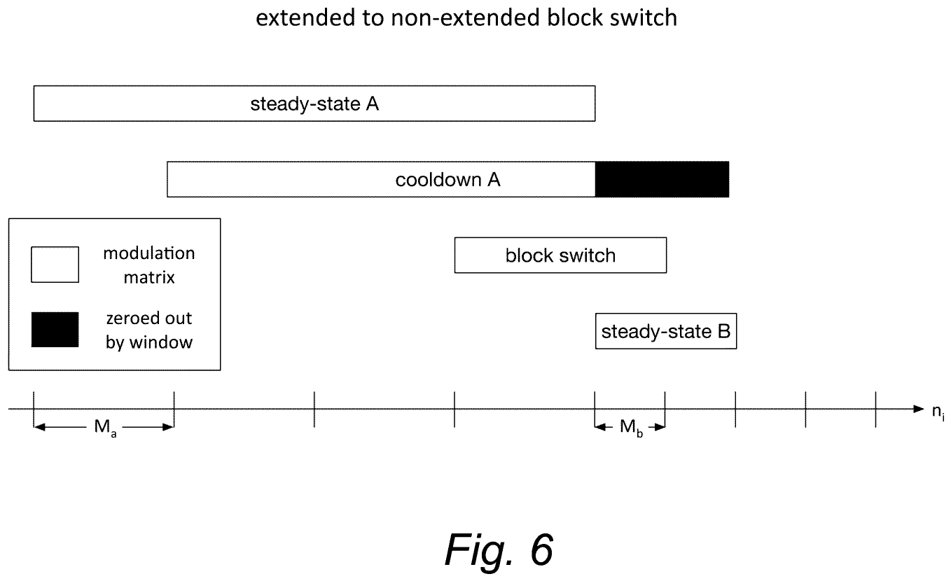

FIG. 5 illustrates an example sequence of extended block switch windows for transitioning between an extended TDAC transform and a non-extended TDAC transform having hop sizes of Mₐ and M_{b}, with mₐ=2 and m_{b}=1. FIG. 6 illustrates the sequence of modulation matrices for performing the transition between the extended TDAC transform and the non-extended TDAC transform.

As can readily be appreciated from FIGS. 5 and FIG. 6, the process for switching between the extended TDAC transform and the non-extended TDAC transform is similar to the process described above with respect to FIGS. 3 and 4, but with the exception that the block switching process does not include a Warmup Phase when switching between the extended TDAC transform and the non-extended TDAC transform. This approach can offer decreased system delay in the non-extended state relative to the extended state with the same hop size.

To achieve the block switch between the extended TDAC transform and the non-extended TDAC transform, a Cooldown Phase A similar to the Cooldown Phase A described above with reference to FIGS. 3 and 4 can be utilized. A switch can then be performed directly to the non-extended TDAC transform using a non-extended Bosi-Davidson block switch with a window wₛ ∈ [symbol] ^{M}^{ₐ}^{+M}^{_{b}} that allows for perfect reconstruction and can be implemented as follows:

$${w}_{s} = ( \begin{matrix}\sqrt{{{w}_{a} [ 0 ]}^{2} + {{w}_{a} [ {M}_{a} ]}^{2}} \\ ⋮ \\ \sqrt{{{w}_{a} [ {M}_{a} - 1 ]}^{2} + {{w}_{a} [ 2 {M}_{a} - 1 ]}^{2}} \\ {w}_{b} [ n + {M}_{b} ] \\ ⋮ \\ {w}_{b} [ n + 2 {M}_{b} - 1 ]\end{matrix} ) ,$$

where w_{b} is the new steady state window.

In some cases, an audio coder may switch between non-extended and extended TDAC transforms to adapt to varying signal characteristics (i.e. the reverse of the transform described above). The decision to switch between non-extended and extended TDAC transforms may be based on factors such as signal transients, spectral flatness, or perceptual criteria derived from psychoacoustic models.

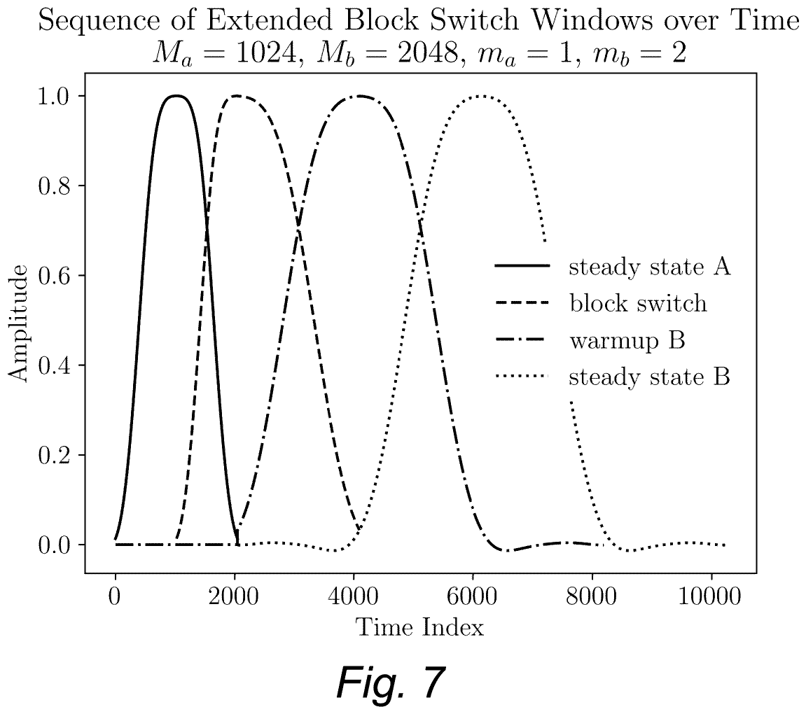

FIG. 7 illustrates an example sequence of extended block switch windows for transitioning between a non-extended TDAC transform and an extended TDAC transform having hop sizes of Mₐ and M_{b}, with mₐ=2 and m_{b}=2. FIG. 7 illustrates the sequence of modulation matrices for performing the transition between the extended TDAC transform and the non-extended TDAC transform.

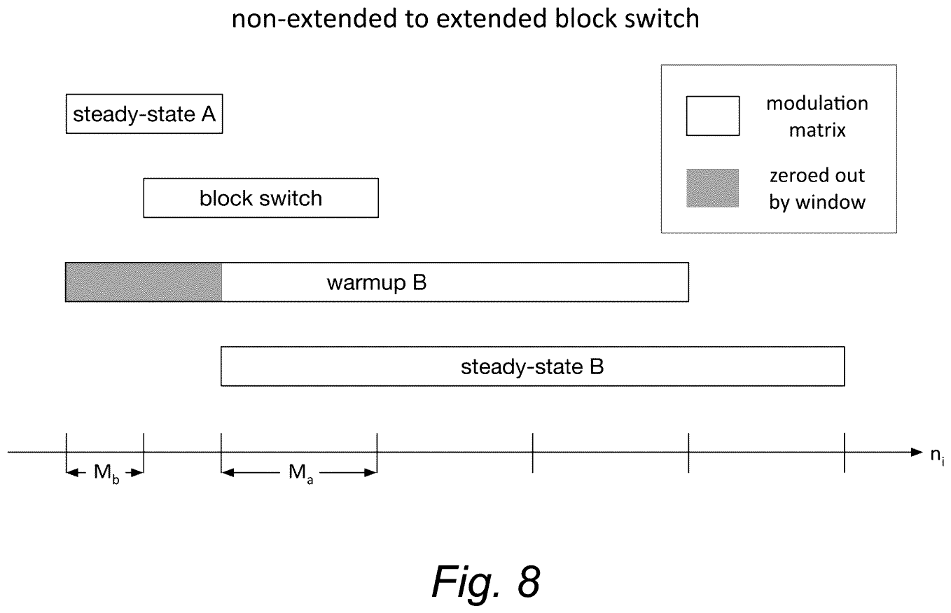

As can readily be appreciated from FIGS. 7 and FIG. 8, the process for switching between the non-extended TDAC transform and the extended TDAC transform is similar to the process described above with respect to FIGS. 5 and 6, but with the exception that the block switching process does not include a Cooldown Phase when switching between the non-extended TDAC transform and the extended TDAC transform, but instead includes a Warmup Phase after the Block Switch Phase similar the Warmup Phase B described above with reference to FIGS. 3 and 4. The switch from the non-extended TDAC transform with hop size Mₐ to the extended TDAC transform with hop size M_{b} can be performed using a window that is the time reversal of the window wₛ (described above with reference to FIGS. 5 and 6) used to switch from an extended TDAC transform with hop size M_{b} to a non-extended TDAC transform with hop size Mₐ.

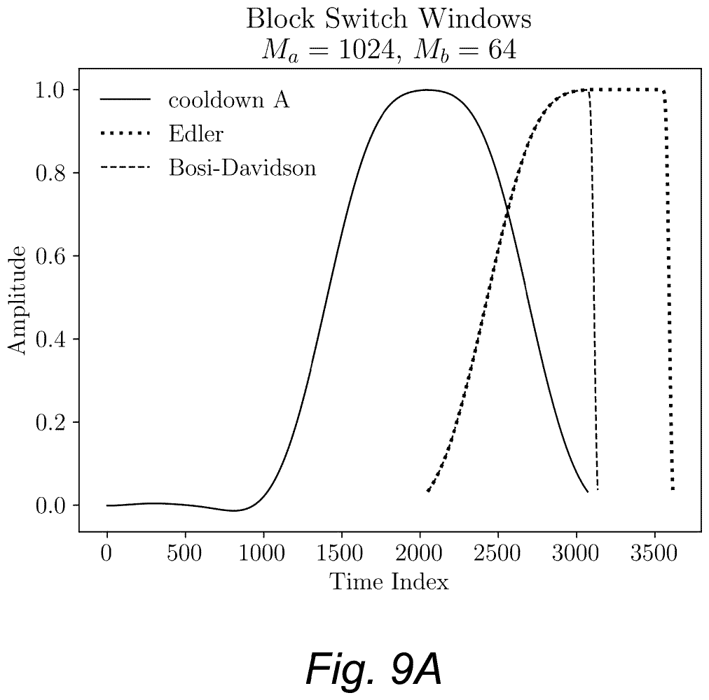

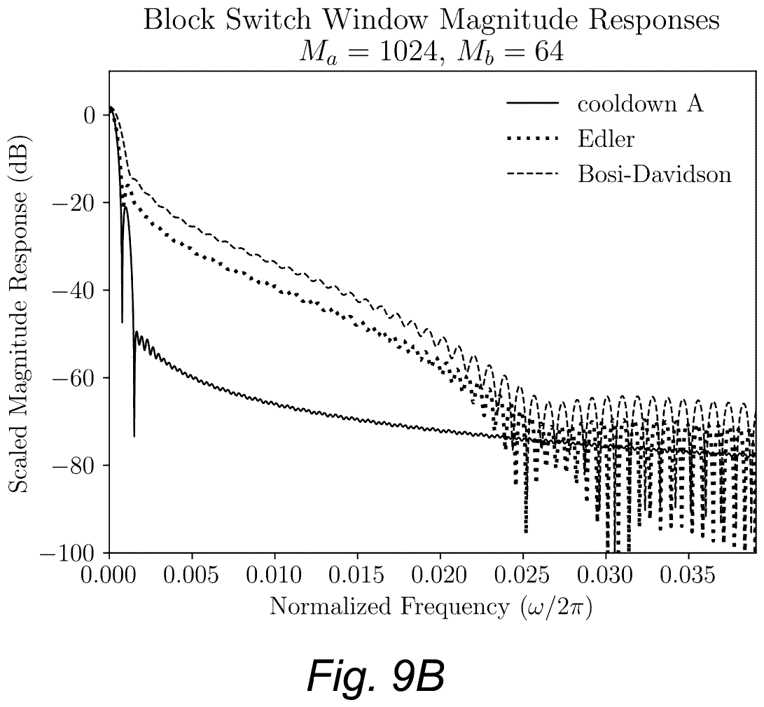

While much of the discussion above focuses on the use of Bosi-Davidson windows to perform block switching, audio processing systems implemented in accordance with several embodiments of the invention may employ different types of block switching methods when transitioning between TDAC transforms. FIG. 9A illustrates a comparison of a Cooldown A window and windows for two different block switch types: an Edler window, and a Bosi-Davidson window. These windows may be used for transitioning between extended TDAC transforms with different hop sizes. In the illustrated embodiment, the initial extended TDAC transform has a hop size Mₐ=1024 and the second extended TDAC transform has a hop size of M_{b}=64. Both extended TDAC transforms employ an extension factor of m=2. FIG. 9B presents a comparison of the scaled magnitude responses for the three block switch window types.

The characteristics of these block switch windows may influence the overall performance of the TDAC transform during transitions. Factors such as pre-echo reduction, artifact minimization, and preservation of signal energy may be affected by the choice of window function. Accordingly, audio processing systems implemented in accordance with many embodiments of the invention are capable of selecting and implementing appropriate block switch windows based on the specific requirements of the application and the nature of the input audio signals being processed.

While specific processes for performing block switching between various extended and non-extended TDAC transforms are described above with reference to FIGS. 3-9B, any of a variety of block switches can be performed in audio processing systems and methods implemented in accordance with various embodiments of the invention. In some cases, different types of extended and non-extended TDAC transforms and/or extended and non-extended TDAC transforms having different hop sizes, different sets of cooldown and warmup phases, different switching windows, and/or associated modulation matrices may be utilized within an audio processing system as appropriate to the requirements of specific applications. The specific choice of features of the block switch including (but not limited to) transform types, modulation matrix sequences, and transition methods may depend on the requirements of different applications, such as the need for improved frequency resolution, reduced pre-echo artifacts, and/or enhanced coding efficiency.

As can readily be appreciated, the implementation of audio processing systems, audio encoders, audio decoders, and/or filter banks based upon the adaptive extended TDAC transforms described herein may be realized through various hardware or software configurations. In some cases, dedicated hardware accelerators, general-purpose processors configured by machine readable instructions stored in memory components, or a combination of both may be used to perform the transform computations efficiently.

A number of implementations have been described. Nevertheless, it will be understood that various modifications may be made without departing from the spirit and scope of the disclosure. Accordingly, other implementations are within the scope of the following claims.

What is claimed is:

1. An audio processing system, comprising:
an audio encoder comprising a time domain to frequency domain mapping filter bank capable of performing an adaptive extended time-domain aliasing cancellation (TDAC) transform, where the adaptive extended TDAC transform comprises a discrete trigonometric transform preceded by a folding matrix; and
an audio decoder configured to decode audio signals encoded by the audio encoder using a frequency domain to time domain to mapping filter bank capable of inverting the adaptive extended TDAC transform using the transpose of the DTT and folding matrix.

2. The system of claim 1, wherein the audio encoder is capable of switching between different extended TDAC transforms using a process comprising:
applying an initial extended TDAC transform with a first hop size and a first extension factor using a first steady-state window;
applying a cooldown window to the initial transform to gradually reduce the window length of the initial extended TDAC transform;
applying a block switch window to bridge between the initial extended TDAC transform and a second extended TDAC transform;
applying a warmup window to introduce the second extended TDAC transform; and
applying the second extended TDAC transform with a second hop size and a second extension factor using a second steady-state window.

3. The system of claim 2, wherein the block switch window has a total length equal to a sum of the first hop size and the second hop size.

4. The system of claim 2, wherein the block switch window is a Bosi-Davidson non-extended block switching window.

5. The system of claim 1, wherein the audio encoder is capable of switching between an extended TDAC transform and a non-extended TDAC transform using a process selected from the group consisting of:
a first process for switching between an extended TDAC transform and a non-extended TDAC transform comprising:
first, applying an initial extended TDAC transform with a first hop size and a first extension factor greater than 1;
then, applying a cooldown window to the initial transform to gradually reduce the window length of the initial extended TDAC transform;
then, applying a block switch window to bridge between the extended TDAC transform and the non-extended TDAC transform; and
then, applying the non-extended TDAC transform with a second hop size and an extension factor of 1; and
a second process for switching between a non-extended TDAC transform and an extended TDAC transform comprising: first, applying a non-extended TDAC transform with a first hop size and an extension factor of 1;
then, applying a block switch window to bridge between the non-extended TDAC transform and an extended TDAC transform;
then, applying a warmup window to gradually increase the window length of the extended TDAC transform; and
then, applying the extended TDAC transform with a second hop size and second extension factor greater than 1.

6. The system of claim 5, wherein the block switch window has a total length equal to a sum of the first hop size and the second hop size.

7. The system of claim 5, wherein the block switch window is a Bosi-Davidson non-extended block switching window.

8. The system of claim 1, wherein the extended TDAC transform is implemented using a fast discrete trigonometric transform of size L/2 m, where L is a window length.

9. The systems of claim 8, wherein the fast discrete trigonometric transform emulates or employs a fast Fourier transform.

10. The system of claim 1, wherein the audio encoder implements an extended TDAC transform block switch using a fast discrete trigonometric transform of size L/2, where L is a Bosi-Davidson non-extended block switch window length.

11. The systems of claim 10, wherein the fast discrete trigonometric transform emulates or employs a fast Fourier transform.

12. The system of claim 1, wherein the adaptive extended TDAC transform comprises at least one of:
an extended evenly stacked TDAC (ETDAC) transform; and
an extended oddly stacked TDAC (OTDAC) transform.

13. The system of claim 1, wherein the audio encoder is configured to adapt a hop size of the adaptive extended TDAC transform based on characteristics of an input audio signal.

14. The system of claim 1, wherein the adaptive extended TDAC transform further utilizes a steady state window characterized by paraunitary lattice coefficients optimized for minimum stopband energies beyond cutoff frequencies ωₛ greater than π/M.

15. An audio encoder, comprising:
a time domain to frequency domain mapping filter bank that is capable of receiving an input audio signal and perform an adaptive extended time-domain aliasing cancellation (TDAC) transform, wherein the adaptive extended TDAC transform comprises a discrete trigonometric transform preceded by a folding matrix;
a psychoacoustic processor operatively connected to the time domain to frequency domain mapping filter bank that is capable of analyzing the input audio signal to determine masking thresholds;
a quantizer and encoder operatively connected to the time domain to frequency domain mapping filter bank and the psychoacoustic processor, where the quantizer and encoder is capable of quantizing the frequency domain outputs from the time domain to frequency domain mapping filter bank based on the masking thresholds; and
a bit stream formatter operatively connected to the quantizer and encoder and capable of packaging the encoded data into a formatted compressed bitstream.

16. The audio encoder of claim 15, wherein the time domain to frequency domain mapping filter bank is capable of switching between different extended TDAC transforms using a process comprising:
applying an initial extended TDAC transform with a first hop size and a first extension factor using a first steady-state window;
applying a cooldown window to the initial transform to gradually reduce the window length of the initial extended TDAC transform;
applying a block switch window to bridge between the initial extended TDAC transform and a second extended TDAC transform;
applying a warmup window to introduce the second extended TDAC transform; and
applying the second extended TDAC transform with a second hop size and a second extension factor using a second steady-state window.

17. The audio encoder of claim 15, wherein the extended TDAC transform is implemented using a fast discrete trigonometric transform of size L/(2 m), where L is a window length and m is an extension factor.

18. The audio encoder of claim 15, wherein the adaptive extended TDAC transform comprises an extended evenly stacked TDAC (ETDAC) transform.

19. An audio decoder capable of decoding a formatted encoded bitstream created using an adaptive extended time-domain aliasing cancellation (TDAC) transform, where the adaptive extended TDAC comprises a discrete trigonometric transform (DTT) preceded by a folding matrix, the audio decoder comprising:
a bit stream demultiplexer capable of receiving and demultiplexing the formatted encoded bitstream;
a decoder and dequantizer operatively connected to the bit stream demultiplexer and capable of processing the demultiplexed bitstream to output a frequency domain representation of a received audio signal; and
a frequency domain to time domain mapping filter bank operatively connected to the decoder and dequantizer and capable of converting the frequency domain representation of the received audio signal to a time domain representation of the received audio signal, wherein the frequency domain to time domain mapping filter bank is capable of inverting the adaptive extended TDAC transform using the transpose of the DTT and folding matrix. The audio decoder of claim 19, wherein the adaptive extended TDAC transform comprises an extended evenly stacked TDAC (ETDAC) transform.
